(19) United States
(12) Patent Application Publication
(10) Pub. No.: US 2005/0262789 A1
(43) Pub. Date: Dec. 1, 2005

(54) Modular construction assembly

(76) Inventor: Pablo Raba Novoa, Caracas (VE)

Correspondence Address: MALLOY & MALLOY, P.A., 2800 S.W. Third Avenue, Historic Coral Way, Miami, FL, 33129, US

(21) Appl. No.: 11/199,822

(22) Filed: Aug. 9, 2005

Related U.S. Application Data
(63) Continuation-in-part of application No. 10/098,897, filed on Mar. 14, 2002.

(51) Int. Cl. E06B 9/08

(52) U.S. Cl. 52/473

(57) ABSTRACT

A modular construction assembly includes a plurality of modular construction members each having a passageway structured to receive and engage at least a portion of an interconnection assembly therethrough. The interconnection assembly comprising one or more interconnection members structured to removably interconnect the plurality of modular construction members to one another to form a modular construction unit, the modular unit disposable into a plurality of arrangements. The interconnection assembly further structured to permit interconnection of a plurality of modular construction units to one another, in a variety of configurations, thereby permitting quick and easy assembly of a variety of structures.

### CLAIM OF PRIORITY

The present application is a Continuation-In-Part patent application of previously filed and currently pending U.S. patent application having Ser. No. 10/298,897, which was filed on Oct. 18, 2002, and is incorporated herein by reference.

### BACKGROUND OF THE INVENTION

1. Field of the Invention

This invention relates to a modular construction assembly comprising a plurality of modular construction units. Each modular construction unit includes a plurality of modular construction members which are quickly, easily, and removably interconnected to one another via an interconnection assembly comprising one or more interconnection members. The plurality of modular construction units are disposable into any of a plurality of configurations via the interconnection assembly thereby permitting the construction of a wide variety of structures including, by way of example only, tables, shelves, benches, staircases, shutters, or even complete enclosures.

2. Description of the Related Art

Among the wide variety of structures which may be constructed from the modular construction assembly of the present invention are shutters, as noted above. In the protection of both domestic and commercial buildings, the use of shutters, exteriorly mounted in a protective position relative to doors, windows or other portals, is known. Naturally, shutter protection in geographical areas subject to extreme weather conditions, such as hurricanes and the like, is even more common. As such, conventionally structured shutters may be permanently and movably attached, frequently in some type of decorative arrangement, to the exterior of the building. Regardless of the geographical area in which shutters are used, they may also be removably attached in an intended protective position relative to various portions of a building or other structure. In the simplest form, shutters are created on an “emergency” basis by merely nailing or otherwise securing sheets of rigid material, such as plywood or the like, in overlying relation to windows, doors, etc.

Because of the popularity and extensive use of shutters the individual structural features thereof may vary greatly. Also, while known shutter structures are used to protect a building against damage from storms, many shutter structures are also designed to provide a measure of security in preventing or resisting unauthorized entry through a window or door, whether or not the building is occupied. In this latter category of conventional shutter structures, many designs are intended to be permanently secured to the exterior of a dwelling in a manner which allows viewing therethrough by individuals from the interior of a dwelling or other building.

Because of the extensive use of shutter assemblies many conventional structures are designed to provide adequate protection and security while at the same time enhancing the overall aesthetic appearance of the exterior of a building on which they are used. In these more sophisticated shutters, some type of support frame is secured about and at least partially defines the periphery of the shutter. In addition a plurality of slats or louvers are either fixedly or movably mounted to the frame, wherein in the latter category the spacing between the individual louvers or slats may be adjusted to facilitate viewing, air circulation, etc. Whether a shutter structure is of the type incorporating fixed or movable louvers, a primary area of concern is the structural features which serve to mount or secure the plurality of louvers to a supporting frame in a manner which accomplishes the intended fixed or movable orientation of the louvers in an effective, reliable and efficient manner. A problem that is common to known shutter structures incorporating fixed or movable slats or louvers is the difficulty and the expense of removing, and repairing or replacing an individual slat or louver that has been damaged.

Another category of more sophisticated high impact, storm resistant shutters comprises a plurality of slats interconnected to one another along corresponding, longitudinal edges thereof. The slats are arranged in a somewhat “layered” configuration or, alternatively, are movably secured to one another about the aforementioned longitudinal edges in somewhat of an accordion type of configuration. This latter shutter structure allows the individual slats to be collapsed or folded upon themselves such that the entire shutter assembly may be easily disposed in either a stored position or extended along a supporting frame into an expanded, operative position in overlying, protecting relation to a door, window, etc. Shutters of this type present an even greater problem, as should be apparent, when a slat or slats are damaged, and must be replaced.

As set forth above, protective shutter structures may assume a variety of different structural configurations. However, in recent years extreme weather, including hurricanes has caused massive damage to certain areas of the United States. As a result, many states mandate significantly stringent code requirements for shutters in order to provide adequate protection to both homes and businesses. By way of example, a building code presently enforced in South Florida is considered one of the nations most stringent and requires that shutters withstand specific impact forces in order to comply with the code requirements. As a result, many previously installed shutters presently being utilized in the state of Florida and in other locations may not have sufficient structural integrity to meet local code requirements.

Therefore, there is a recognized need in the shutter industry for an improved or preferred shutter assembly which overcomes the well known disadvantages and problems recognized in the industry. For example, it would be beneficial to provide a shutter assembly having individual shutter slats which are easy to install, remove, and/or replace. Additionally, a shutter assembly having the versatility of being fixedly or removably attached to the building or other structure with which it is associated, would be helpful. Also, such an improved shutter assembly should have the structural versatility of including a plurality of slats which are removably secured to a frame or other mounting assembly in a manner which easily allows the user to vary the configuration or array of the slats. Of course, any such improved shutter assembly must meet all local and/or state code requirements in terms of impact resistant capabilities.

By way of example, a preferred shutter assembly should be capable of providing a “closed” configuration wherein a window, door, etc. is completely covered. Alternatively, such a preferred shutter assembly should allow fixed or adjustable spacing between the individual slats so as to provide meaningful security against unauthorized entry during periods when maximum protection against storms and bad weather is not a primary concern. Further, when such an improved or preferred shutter assembly is installed either permanently or temporarily, the overall appearance thereof should not detract from the exterior appearance of the building on which it is mounted. Finally, the material from which a preferred shutter assembly is formed should be substantially rigid and high strength but sufficiently light weight to facilitate its installation and/or removal by one or a few untrained individuals in a relatively short period of time.

In addition to a shutter assembly, it would be beneficial to provide an improved modular construction assembly that includes a plurality of construction units each having a plurality of construction members which are easy to install, remove, and/or replace. Also, it would be helpful for such a modular construction assembly to include a plurality of construction units which may be removably and interchangeably disposed into a plurality of predetermined configurations encompassing any of a plurality of structures. In addition, it would be preferable for such a modular construction assembly to comprise an interconnection assembly structured to facilitate disposition of the plurality of construction units into a plurality of predetermined configurations. It would also be preferable for such a modular construction assembly to incorporate modular construction members comprising a unique configuration to provide structural integrity to each individual construction member as well as, collectively, to each corresponding construction unit.

### SUMMARY OF THE INVENTION

The present invention may be utilized to construct a shutter assembly of the type capable of being attached to a supporting structure such as a dwelling, industrial building or a variety of other structures. When mounted in its operative position, the shutter assembly of the present invention provides protection against property damage due to storms, hurricanes or other extreme whether conditions. In addition, the subject shutter assembly is capable of assuming any one of a plurality of predetermined structural configurations, wherein a plurality of slats associated with the shutter assembly are oriented in different arrays dependent, at least in part, on the intended function of the shutter assembly at a particular time.

By way of example, one predetermined array of the plurality of slats may be a “closed” configuration, wherein the plurality of slats are disposed in confronting engagement with one another so as to completely cover an area, such as a window or the like, of the building or other structure being protected. Alternatively, the slats may be oriented in spaced relation to one another to provide a more “open” configuration which allows viewing by occupants within the building therethrough, while providing meaningful protection particularly against unauthorized entry of the window, door, or other portion of the building or other structure with which the shutter assembly is associated.

More specifically, the shutter assembly of the present invention comprises at least one but preferably a plurality of peripheral base segments disposed in spaced apart relation to one another and located at opposite ends of a supporting frame assembly. The frame assembly further comprises a mounting assembly including a plurality of spaced apart mounting members preferably formed of rigid, high strength material rods or like elongated members. The mounting members have their opposite ends connected to correspondingly positioned ones of the base segments in a manner which will be described in greater detail hereinafter. The mounting members or rods are preferably disposed in transverse relation to the connected base segments and in parallel relation to one another. The number of mounting members may vary from at least one to a plurality, dependent on the overall size and configuration of a given shutter assembly, which may of course vary dependent on a particular and intended application thereof.

The aforementioned plurality of slats are mounted on the supporting frame in any one of a plurality of predetermined arrays. As such, the plurality of slats are collectively disposed to extend along a length of the frame assembly between the base segments or along the entire distance between the base segments, dependent on the preferred configuration or predetermined array which the plurality of slats assume. It is emphasized that the term “slat” is used herein in its broadest descriptive sense and is specifically not limited to an elongated, flat, louver like structure. To the contrary, as used herein, in one embodiment the slats may comprise a hollow interior portion extending along at least a portion of the length of the individual slats and preferably along substantially the entire length thereof, while in another embodiment the slats may comprise a substantially solid configuration. Further each of the plurality of slats has closed or capped ends as well as at least partially closed longitudinal sidewalls or edges. In addition, each of the slats are formed from a substantially rigid, high strength material, preferably lightweight, material such as, but not limited to, aluminum, aluminum alloy, steel or other metals. A variety of other materials may also be used to form the slats, including, by way of example only, wood and/or high strength plastic, wherein such material demonstrates sufficient structural integrity, including strength, rigidity, etc. to resist high impact forces during the aforementioned types of extreme weather conditions.

Another feature associated with each of the plurality of slats is the provision of a passageway formed therein. More specifically, the passageway of each slat comprises at least one or preferably a plurality of passages extending transversely therethrough. The passages are dimensioned, disposed and sufficient in number to accommodate the passage therethrough of one of the plurality of mounting members to which the plurality of slats are connected. Accordingly, individual ones of the passages in the plurality of slats are disposed in a predetermined linear alignment with one another such that a corresponding passage in each slat receives a common one of the plurality of mounting members. It should be apparent that based on the disposition of the plurality of mounting members relative to the plurality of slats and the fact that the mounting members are formed from a substantially rigid, high strength material, the mounting members serve not only as an efficient means of interconnecting and supporting the plurality of slats, but also as a reinforcement structure which enhances the ability of the shutter assembly to resist high impact forces.

Another feature of at least one preferred embodiment of the shutter assembly of the present invention is the provision of a locking assembly which secures the plurality of slats to one another and/or to the plurality of mounting members passing through the plurality of slats. When utilized, the locking assembly of the present invention includes at least one but preferably a plurality of locking members which may be equal in number to the number of mounting members. Moreover, the locking members are secured or otherwise structured to receive corresponding ends of the mounting members. In addition, each of the one or more locking members includes through channels oriented transversely to the disposition of the mounting members to which they are secured. Connecting members, such as bolts or like anchoring structures, pass into the through channels and are embedded, anchored or otherwise affixed to the surface or other portion of the supporting structure on which the shutter assembly of the present invention is mounted.

Accordingly, the shutter assembly of the present invention, in each of its preferred embodiments, may be quickly and efficiently secured in its operative, protective position on the exterior or other portion of a building or other structure. When so positioned, the plurality of slats protectively overly or cover a window, door or other area of the building intended to be protected. Further the plurality of slats are removably connected to the plurality of mounting members, such that they may be alternatively arranged in a variety of different predetermined arrays depending upon the intended purpose and function of the shutter assembly of the present invention.

The present invention further comprises a modular construction assembly as indicated above which may be utilized to quickly, easily, and removably assembly a plurality of structures including, by way of example only, tables, chairs, shelves, stairs, etc. The modular construction assembly comprises a plurality of modular construction units, each having a corresponding plurality of modular construction members collectively disposed in at least one of a plurality of predetermined arrays.

The modular construction members of the present invention comprise a generally elongated configuration having an interior portion and an exterior portion, and at least one pair of oppositely disposed faces. In at least one embodiment, the modular construction members include a pair of oppositely disposed major faces and an adjoining pair of oppositely disposed minor faces. Further, the modular construction members comprise at least one internal support element disposed along a length of the member and structured to interconnect the pair of major faces, thereby providing additional structural integrity to the modular construction member. Additionally, in at least embodiment, one of the major faces of the modular construction members comprises at least one non-planar portion also structured and disposed to provide additional structural integrity thereto. The modular construction members of the present invention also include a passageway formed therethrough which is structured to receive at least a portion of an interconnection assembly.

As indicated above, the modular construction assembly of the present invention further comprises an interconnection assembly structured to operatively engage the plurality of modular construction members. More in particular, the interconnection assembly includes a plurality of interconnection members, each of the interconnection members comprising an elongated configuration and having opposite ends. Further, at least a some of said plurality of interconnection members are structured and disposed to extend through the passageways of the plurality of modular construction members, thereby securely yet removably interconnecting corresponding ones of the plurality of modular construction members to one another in one of the plurality of predetermined arrays, thereby forming one of the plurality of modular construction units. The interconnection assembly is further structured to securely yet removably interconnect the plurality of modular construction units to one another in one of the plurality of predetermined configurations to form one of the plurality of structures which may be removably assembled via the modular construction assembly of the present invention.

These and other objects, features and advantages of the present invention will become apparent when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a front plan view of a shutter assembly of the present invention wherein a plurality of slats thereof are disposed in closed configurational array.

FIG. 2 is a front plan view of the shutter assembly of the present invention wherein the plurality of slats are interconnected in an at least partially open configurational array.

FIG. 3 is a front plan view of a frame assembly portion of the embodiments of FIGS. 1 and 2.

FIG. 4 is a sectional view in partial cutaway along line 4-4 of FIG. 3.

FIG. 5 is a sectional view in partial cutaway along line 5-5 of FIG. 2.

FIG. 6 is a front plan view of one of a plurality of slats associated with a preferred embodiment of the shutter assembly of the present invention.

FIG. 7 is a top view of the embodiment of FIG. 6.

FIG. 8 is a front plan view of one of a plurality of mounting members associated with at least one preferred embodiment of the shutter assembly of the present invention.

FIG. 9 is a sectional view in partial cutaway of one of a plurality of spacer members associated with a spacer assembly of a preferred embodiment of the shutter assembly of the present invention.

FIG. 10 is a detail view in perspective of one spacer member of the embodiment of FIG. 9.

FIG. 11 is a sectional view of one of a plurality of locking members associated with a locking assembly of at least one preferred embodiment of the shutter assembly of the present invention.

FIG. 11A is a sectional view of one of a plurality of locking members associated with another embodiment of the locking assembly of the present invention.

FIG. 12 is a perspective view in partial cutaway disclosing a plurality of locking members of the embodiment of FIG. 11 shown in an at least partially assembled position.

FIG. 13 is a perspective view of one preferred embodiment of a modular construction unit of the present invention illustrating a plurality of modular construction units disposed in a closed array.

FIG. 14 is a perspective view of one other preferred embodiment of a modular construction unit of the present invention illustrating a plurality of modular construction units disposed in a partially open array.

FIG. 15 is a perspective view of one preferred embodiment of a modular construction member of the present invention.

FIG. 15A is an alternate perspective view of the embodiment of the modular construction member of FIG. 15 further illustrating a passageway.

FIG. 16 is a perspective view of a portion of one preferred embodiment of an interconnection assembly of the present invention.

FIG. 17 is a plan view of one preferred embodiment of an interconnection member of the interconnection assembly of the embodiment of FIG. 16.

FIG. 18 is a perspective view of one preferred embodiment of an interconnection bushing of the interconnection assembly of the embodiment of FIG. 16.

FIG. 19 is a partially exploded cross-sectional view of one portion of an interconnection assembly of the present invention.

FIG. 20 is a perspective view of the embodiment of the modular construction unit of FIG. 13 further illustrating one preferred embodiment of cover members.

FIG. 21 is a perspective view of a modular construction unit of the present invention wherein a plurality of modular construction units thereof are disposed in a predetermined partially open array and further comprising cover members.

FIG. 22 is a cross-sectional view of the embodiment of FIG. 21 along lines 22-22 thereof illustrating a portion of an interconnection member disposed through the passages of a modular construction member.

FIG. 23 is a cross-sectional view of the embodiment of FIG. 21 along lines 23-23 thereof illustrating an interconnection bushing being received within a hollow interior portion of a cover member.

FIG. 24 is a perspective view of a table constructed from the modular construction assembly of the present invention.

FIG. 25 is a perspective view of a table having adjoining bench style seats constructed from the modular construction assembly of the present invention.

FIG. 26 is a perspective view of a wall mounted shelf constructed from the modular construction assembly of the present invention.

FIG. 27 is a perspective view of a free standing shelf constructed from the modular construction assembly of the present invention.

FIG. 28 is a perspective view of a staircase constructed from the modular construction assembly of the present invention.

Like reference numerals refer to like parts throughout the several views of the drawings.

### DETAILED DESCRIPTION OF THE PREFERRED EMBODIMENT

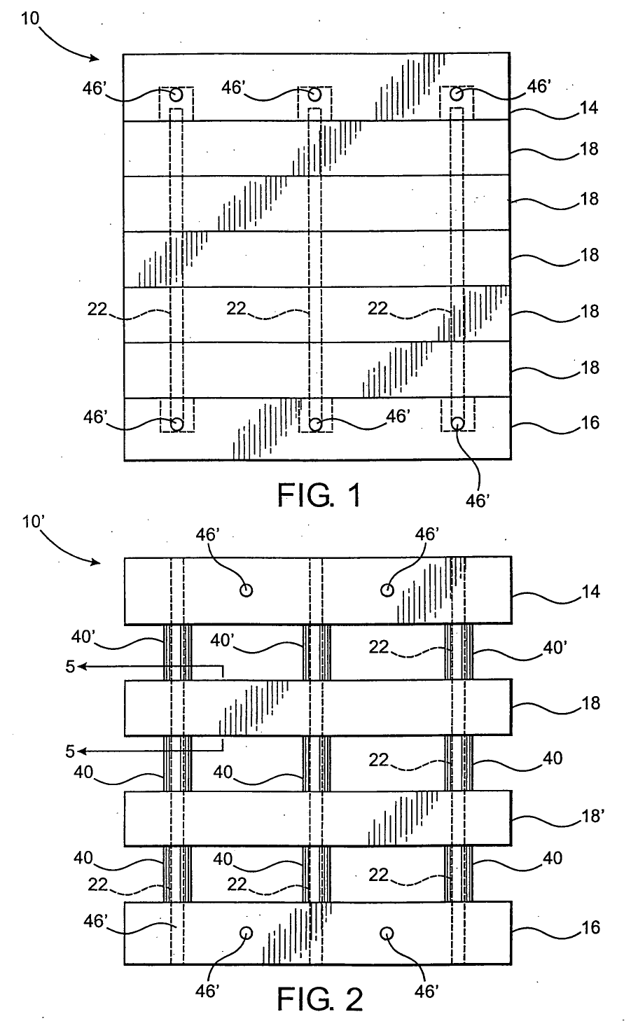

As shown in the accompanying FIGS. 1 through 12, the present invention may be utilized to construct a shutter assembly generally indicated as 10. The shutter assembly 10 is structured to be removably or fixedly secured to the exterior of a domestic, commercial or other type of building structure. As such, the building to which the shutter assembly 10 is attached will serve as a supporting structure, as set forth in greater detail hereinafter. The specific supporting structures referred to herein may of course vary and for purposes of clarity are not shown in the accompanying Figures. Further, the shutter assembly 10 is designed to substantially overly and fully or at least partially cover windows, doors, or other portals as well as other portions of a building or other structure which require protection. In its various operable configurations, the shutter assembly 10 may be used to provide protection from storms, hurricanes or other extreme weather conditions as well as prevent unauthorized entry through a window, door, etc.

Therefore, the shutter assembly 10 comprises a frame assembly protective structural features of the shutter assembly 10 by the inclusion of at least one, but preferably a plurality of base one another. Each of the base segments 14 and 16 define a peripheral portion of the frame assembly 12 and, also as more fully described hereinafter, each of the base segments 14 and 16 resemble one of the plurality of slats 18, both in structure and appearance. As should be apparent, the dimension and configuration of the shutter assembly 10 and, accordingly, the frame assembly 12 may vary, at least partially dependent on the portion of the building or other structure with which it is associated and intended to protect. As such, the number and/or dimensions of the plurality of slats 18 may vary. Additionally, the slats 18 shown throughout the figures comprise a generally flat, rectangular surface configuration, however, this is solely for the purpose of ease of illustration, as it is understood to be within the scope of the present invention for the slats 18 to comprise a variety of surface configurations including, by way of example only, rounded, conical, triangular, concave, convex, etc., such as may be preferable for aesthetic as well as structural considerations.

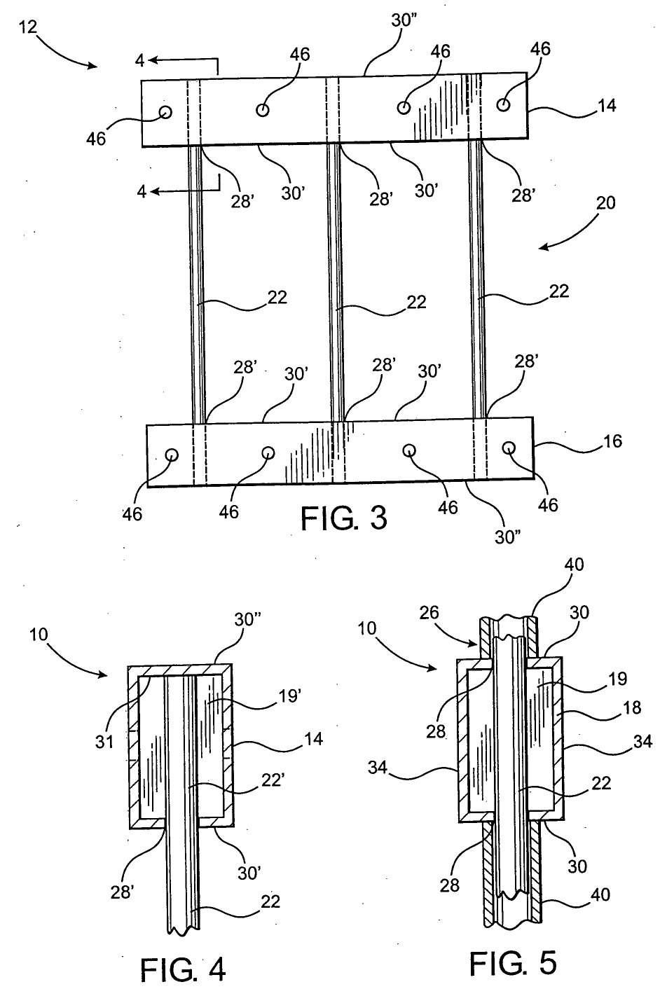

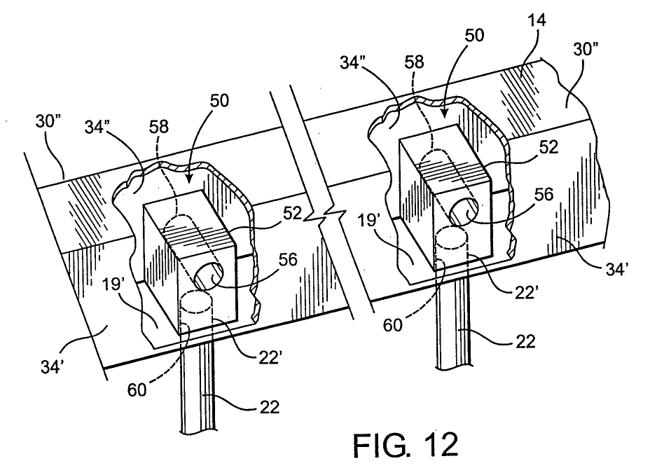

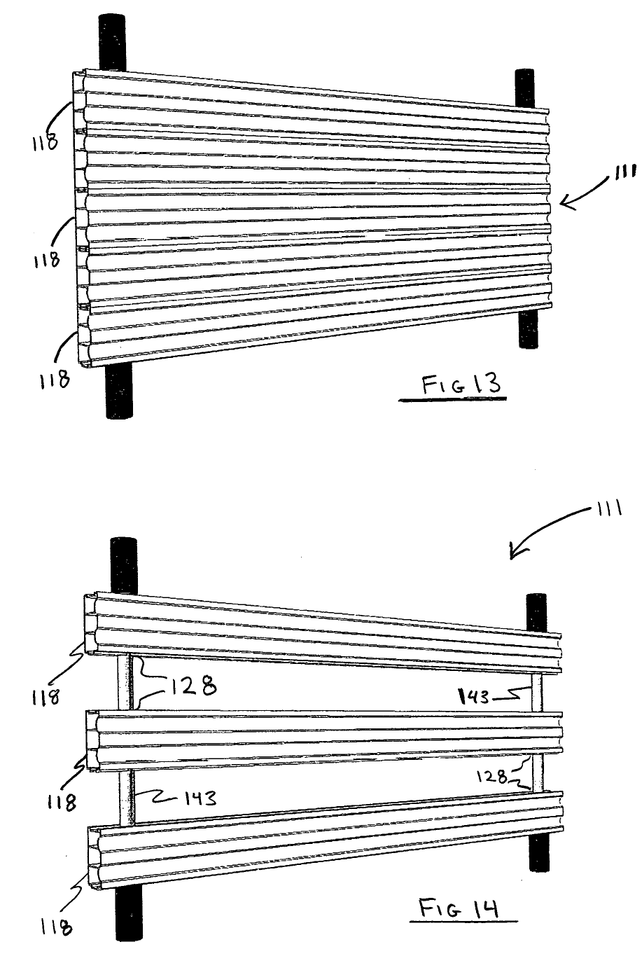

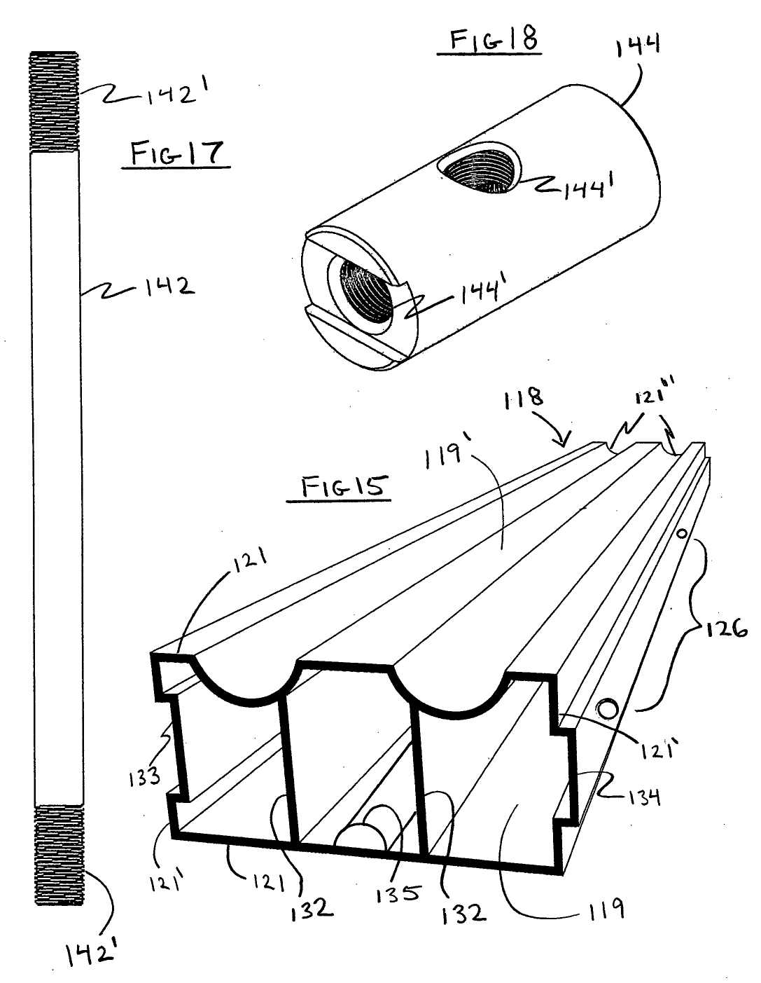

The frame assembly 12 further comprises a mounting assembly generally indicated as 20. The mounting assembly 20 includes at least one but preferably a plurality of mounting members 22 disposed in spaced, preferably parallel relation to one another as best shown in FIG. 3. Further, each of the mounting members 22 of the base segments 14 and 16. Depending on which of the preferred embodiments of the shutter assembly 10 are being utilized, one or both of the opposite ends 22′ of the plurality of mounting members 22 may be threaded or otherwise structured to facilitate connection to the corresponding base segments 14 and 16, as will be described with specific reference to FIGS. 11 and 12.

The mounting assembly 20 and particularly the one or more mounting members 22 serve to connect and at least partially support the plurality of slats 18 in their intended operative position on the frame assembly 12. As such, each of the plurality of mounting members 22 have a sufficiently elongated configuration to extend between the base segments 14 and 16 so as to at least partially define the corresponding length or dimension of the shutter assembly 10. Further, the one or more mounting members 22 are oriented in at least transverse relation to each of the base segments 14 and 16, and are preferably oriented essentially perpendicular thereto, as clearly shown in FIG. 3.

It is also emphasized that the number and specific positioning of the one or more mounting members 22 may vary dependent on the dimension and configuration of the completed shutter assembly 10. Also, to provide maximum protection against high impact forces, such as those potentially occurring during a storm, each of the mounting members 22, as well as the base segments 14 and 16 and the plurality of slats 18 are formed from a substantially rigid, high strength material such as aluminum, aluminum alloy, steel or other metals. It is of course contemplated that other materials having sufficient structural integrity may be utilized including, but not limited to, wood, high strength plastics, etc. As set forth above, the mounting members 22 serve to connect and at least partially support the plurality of slats 18, in at least one of a plurality of predetermined arrays, as the plurality of slats 18 collectively extend between the base segments 14 and 16. As illustrated throughout the figures, vertically oriented arrays of the plurality of slats 18 are depicted, however, it is well within the scope and understanding of the present invention to encompass horizontally oriented arrays of the plurality of slats 18 as well.

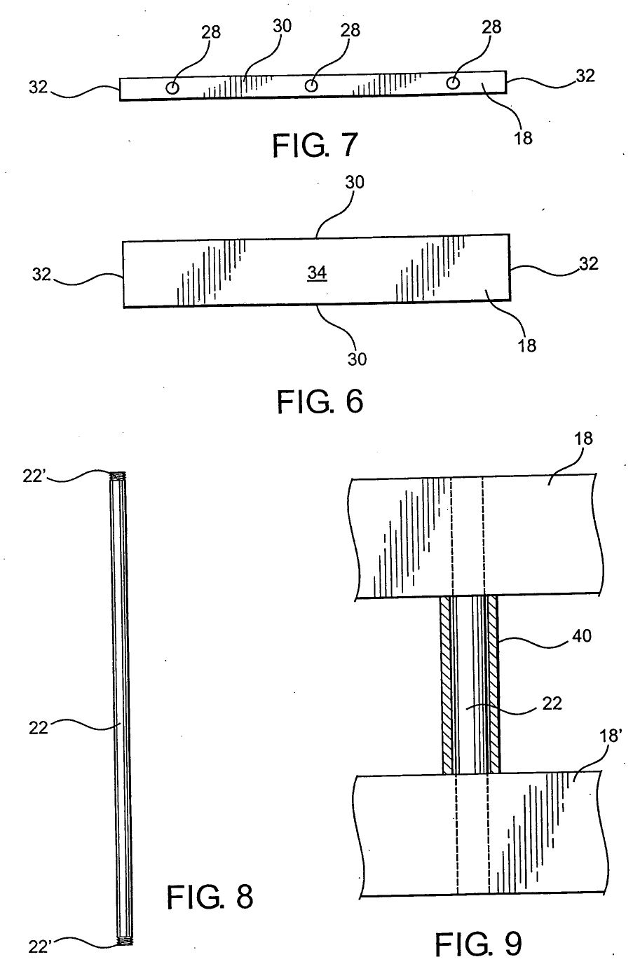

With primary reference to FIGS. 5 through 7, each of the plurality of slats 18 preferably includes a substantially hollow of the length thereof, to reduce the weight of each of the plurality of slats 18. However, it is understood that, alternatively, the plurality of slats 18 may comprise a substantially solid configuration. Attachment of the slats 18 to the frame assembly 12 is facilitated through the provision of a 18. The passageway 26 preferably comprises a plurality of passages 28 formed in oppositely disposed longitudinal sides or edges 30 of each of the slats 18. As such, the passages 28 are disposed and dimensioned to receive and allow passage therethrough of corresponding ones of the mounting members 22. In at least one preferred embodiment, the passages 28 have a substantially round or circular configuration so as to correspond to a preferred sectional configuration of the mounting members 22 which may comprise an elongated rod. Other shapes and structures of both the mounting members 22 and the passages 28 are of course to be included within the intended spirit and scope of the present invention, including, but not limited to elliptical, polygonal, etc. Other structural features associated with a preferred embodiment of the slats 18 include closed end portions 32, as shown in FIGS. 6 and 7, and exposed, oppositely disposed outer faces 34, as shown in FIG. 6, or 34′ and 34″, as further illustrated in FIG. 12.

The base segments 14 and 16 are structured similarly to the plurality of slats 18 in order to receive the one or more mounting members 22 therein. More specifically, each of the innermost longitudinal sides or edges 30′ may include openings or inlets as the interior 19′ of the base segments 14 and 16. The structural features which facilitate securement of the opposite ends 22′ of the mounting members 22 to the base segments 14 and 16 may vary between the preferred embodiment of FIGS. 2, 3, and 4 and an additional preferred embodiment as best shown in FIGS. 1, 11, and 12.

As should be apparent, the passages 28 of the passageway 26 of each of the slats 18 are aligned with one another so as to facilitate the passage therethrough of the one or more mounting members 22, as best shown in FIGS. 1, 2, and 5. Also, the cooperative structuring of the passageways 26 of the plurality of slats 18 and the provision of the one or more mounting members 22 facilitate the removable mounting or securement of the individual slats 18 on the frame assembly 12. Therefore, the slats 18 may be arranged in any one of a plurality of different arrays so as to assume a “closed” configuration, depicted in FIG. 1, or an at least partially “open” configuration, as depicted in FIG. 2. It should also be apparent that the closed configuration of FIG. 1 comprises each of the slats 18 disposed in confronting relation to adjacent ones of the slats 18. Also, the end most slats 18 confrontingly engage the corresponding base segment 14 and 16. This closed configuration defines one of a plurality of predetermined arrays and is intended to provide maximum protection to a portion of the building or other structure on which the shutter assembly 10 is mounted. In at least one embodiment, the plurality of slats 18 are structured and disposed to engage and at least partially interlock with adjacent slats 18, as well as with each of the base segments 14 and 16, thereby providing additional structural integrity to the shutter assembly 10 when the plurality of slats 18 are arranged in a “closed” and interlocked configuration.

However, in the embodiment of FIG. 2, the shutter assembly 10′ includes the plurality of slats 18 being removably disposed in a different predetermined one of a plurality of possible arrays including the aforementioned open configuration. In such an “open” configuration, at least some of the plurality of slats, such as substantially adjacent slats 18 and 18′, may be disposed in spaced relation to one another. Similarly, the slats 18 and 18′ may be disposed in spaced relation to the corresponding base segments 14 and 16. This “open” configuration may provide somewhat less protection against high impact forces prevalent during storm condition, particularly by objects making impact between the slats and 18′. However, such an “open” configuration does allow viewing of the exterior by individuals within the building or other structure being protected, yet prevents access from the exterior other than through the limited opening between slats 18 and 18′.

It should be further noted that the aforementioned “open” configuration may be defined by others of a plurality of possible arrays, such that a greater number of the slats 18 may also be disposed in spaced relation to one another. Alternatively, 16 respectively, may be disposed in confronting relation to one another. Again, the specific number of slats 18 utilized may of course vary dependent on the overall size and configuration of the shutter assembly 10 and/or 10′.

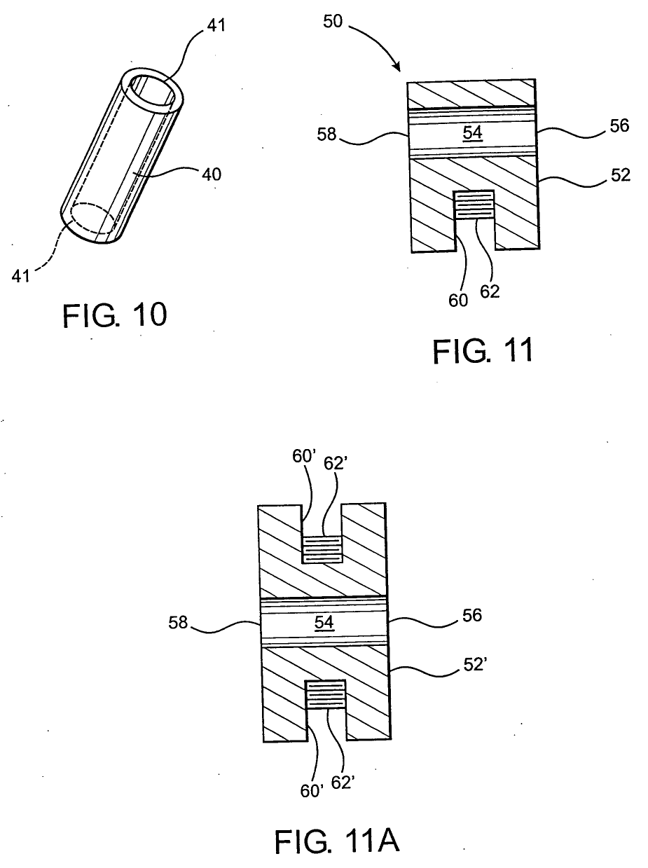

Another structural feature of the shutter assembly 10 and 10′ of the present invention is the provision of a spacing assembly. The spacing assembly preferably comprises a plurality of spacer members 40, as shown in detail in FIG. 10. The spacer members 40 preferably include an elongated configuration corresponding to an intended distance or “spacing” between the adjacent slats 18 and 18′ and/or between a slat 18 and a base segment 14, as depicted in FIG. 2. Further, each of the spacer members 40 includes a hollow interior communicating with oppositely disposed open ends 41. This structural configuration facilitates the passage therethrough of a corresponding mounting member 22. As such, the opposite open ends 41 confront the longitudinal sides or edges 30 and 30′ of adjacently positioned but spaced apart mounting members 18 and/or base segments 14 and 16. Naturally, the longitudinal dimension of each of the spacer elements 40 which are disposed between the same be equal. However, it should also be apparent that the spacing between different slats 18 or between one of the slats 18 and either base segment 14 and 16 may vary based on the longitudinal dimensions of the spacer members 40 and 40′ being different.

In at least one preferred embodiment as shown in FIGS. 2 and 3, the shutter assemblies 10 and/or 10′ are attached to the exterior or other portions of the building or other structure by means of one or more openings 46 formed in and passing completely through the base segments 14 and 16. These openings 46 are dimensioned, disposed and configured to receive some type of connecting anchor such as an elongated anchor bolts. Each of the one or more anchor bolts or like connectors (not shown for purposes of clarity) has their distal or outer most end embedded or otherwise secured to the building or other structure on which the shutter assembly 10 and/or 10′ is mounted.

Therefore, in the preferred embodiment of the shutter assembly 10 as shown in FIGS. 2 and 3, each of the opposite ends 22′ of the one or more mounting members 22 pass through the inlet openings 28′ and engage an interior surface 31 of the outermost longitudinal sidewall 30″ of each of the base segments 14 and 16. Due to the fact that both of the base segments 14 and 16 are securely anchored or otherwise mounted on the building or other structure through the provision of the aforementioned anchoring bolts or like connectors, securely “trapped” within the interior 19′ of the respective base segments 14 and 16.

However, the shutter assembly of the present invention includes yet another preferred embodiment primarily directed to securing the mounting members 22 to the respective base segments 14 and 16. This additional preferred embodiment is also directed to the mounting or attachment of the shutter assembly 10 or 10′ to the building or other structure with which it is associated. With primary reference to FIGS. 1, 11 and 12, this preferred embodiment comprises a locking assembly generally indicated as 50. The locking assembly 50 includes at least one but more practically a plurality of locking members 52. Each of the locking members 52 may be fixedly secured or removably mounted within the interior 19′ of each of the base segments 14 and 16.

Further, each of the locking members 52 includes a through channel 54 communicating with opposite open ends 56 and 58. An open ended receiving channel 60 is disposed in communicating relation with one end of each of the locking members 52. The fixed or removable orientation of the locking members 52 on the interior 19′ of each of the base segments 14 and 16 is such that the opening 56 of the through channel 54 is aligned with one of the connector openings 46′ formed in the respective base segments 14 and 16, as best shown in FIG. 1. Therefore, the securement or anchoring of the base segments 14 and 16 occurs by one of the aforementioned anchoring bolts or like connectors passing completely through channels 54 of each of the one or more locking members 52 so as to be embedded in the building or other structure to which the shutter assembly 10 or 10′ is attached.

Also, a correspondingly positioned one of the opposite ends 22′ of a mounting member 22 passes into the interior of an open ended receiving channel 60. As shown, the receiving channel 60 may engagement with a corresponding one of the opposite ends 22′. As illustrated throughout the figures, the locking members 52 are shown to comprise a substantially rectangular external configuration, however, it is within the scope of the present invention to provide locking members 52 comprising any one of a number of external configurations, including but not limited to square, spherical, cylindrical, triangular, or other geometric configurations as required to facilitate manufacturing, constructability, and/or installation of the shutter assembly 10 of the present invention.

In at least one embodiment, the locking members 52 of the locking assembly 50 may be mounted directly to the building or other structure to which the shutter assembly 10 is to be attached by passing the aforementioned anchoring bolts or like connectors directly through the channels 54 of each of the locking members 52 and directly embedding the connectors into the building or other structure, thereby eliminating the base segments 14 and 16 altogether. In this embodiment, oppositely disposed corresponding ones of the locking members 52 are securely threaded onto the opposite ends 22′ of each of the support members 22 which extend outward through the passages 28 of the outermost slats 18 of the assembly 10, the locking members 52 serving to maintain the plurality of slats 18 in position adjacent one another and/or to spacer members 40 or 40′, and in a protective relation relative to the building or other structure.

In yet another embodiment, the locking members 52′ may comprise an open ended receiving channel 60′ having an internally threaded surface 62′ at either end, as illustrated in FIG. 11A. In this embodiment, one of the threaded ends 22′ of each of a corresponding pair of mounting members 22 is threaded into the opposite ends of the locking member 52′. In this embodiment, the locking members 52′ function as an interface allowing two or more shutter assemblies to be interconnected to each another, via the locking members 52′, as may be required to cover and protect a large or irregular shaped opening in the building or other structure being protected. Of course, it is understood that in this embodiment, the base member 14 or 16 will comprise inlet openings 28′ through both the innermost and outermost longitudinal threaded ends 22′ of each of the corresponding pair of mounting members 22 therethrough and into the opposite ends of the locking members 52′.

When the locking members 52 are removably mounted within the interior 19′ of the base segments 14 and 16, it should be apparent that the interior of each receiving channel 60 associated with the locking members 52 of both of the base segments 14 and 16 may be threaded. As such, the locking members 52 are first threaded onto both opposite ends 22′ of each of the mounting members 22 and subsequently passed into the interior 19′ of the respective base segments 14 and 16. The base segments 14 and 16 are then anchored to the building or other structure in the manner set forth above.

However, when the locking members 52 are fixedly or permanently secured on the interior 19′ of the base segments 14 and 16 at least one set of locking members 52, associated with either the base segments 14 or the base segments 16, should be absent the threaded interior 62 so as to slidingly and freely receive a corresponding one of the opposite ends 22′ of the mounting members 22 therein. Therefore, each of the mounting members 22 may be threaded to the locking members 52 within one of the base segments 14 and 16 and will be freely and slidingly received within the locking members 52 of the other of the base segments 14 and 16.

Therefore, each of the preferred embodiments of the shutter assembly 10 or 10′ of the present invention may be removably or fixedly mounted on the exterior portion of a building or other structure. Moreover, each of the plurality of slats 18 may assume any one of a variety of predetermined arrays defining either a closed configuration as shown in FIG. 1 or in at least partially open configuration as shown in FIG. 2.

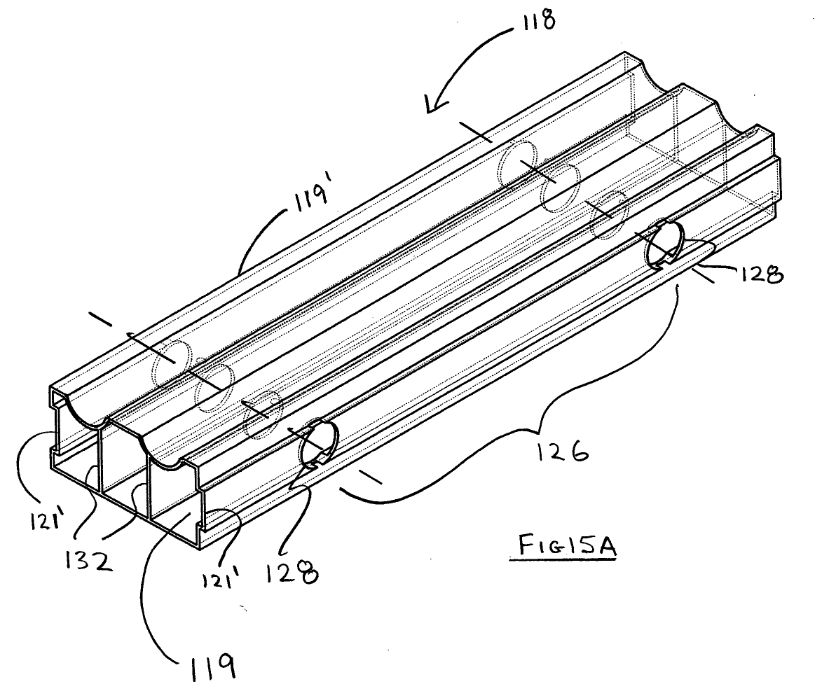

As indicated above, the present invention further comprises a modular construction assembly as described in detail hereinafter and generally as shown at 100 throughout the accompanying figures. The modular construction assembly 100 of the present invention includes at least one, but preferably a plurality of modular construction units 111 such as illustrated, by way of example only, in FIGS. 13 and 14. The plurality of modular construction units 111 of the present invention are structured to cooperatively associate with one another in any of a plurality of configurations to permit the construction of a variety of structures including, but by no means limited to, tables, benches, shelves, stairs, or complete enclosures, and of course, shutter assemblies. Further, the modular nature of the modular construction assembly 100 of the present invention permits the variety of structures to be quickly and easily assembled by removably interconnecting a plurality of modular construction units 111 to one other in any of the plurality of configurations to permit the user to utilize the present invention to accomplish a variety of construction goals without the need for a variety of complex construction materials, techniques, and/or equipment.

To begin, each modular construction unit 111 of the present invention comprises at least one, but preferably a plurality of modular construction members 118. As shown throughout the figures, the modular construction members 118 comprise a generally flat, rectangular configuration, however, this is solely for ease of illustration, and it is understood to be within the scope of the present invention for the modular construction members 118 to comprise a variety of configurations including, by way of example only, rounded, conical, triangular, concave, convex, etc., such as may be preferable for aesthetic as well as structural considerations.

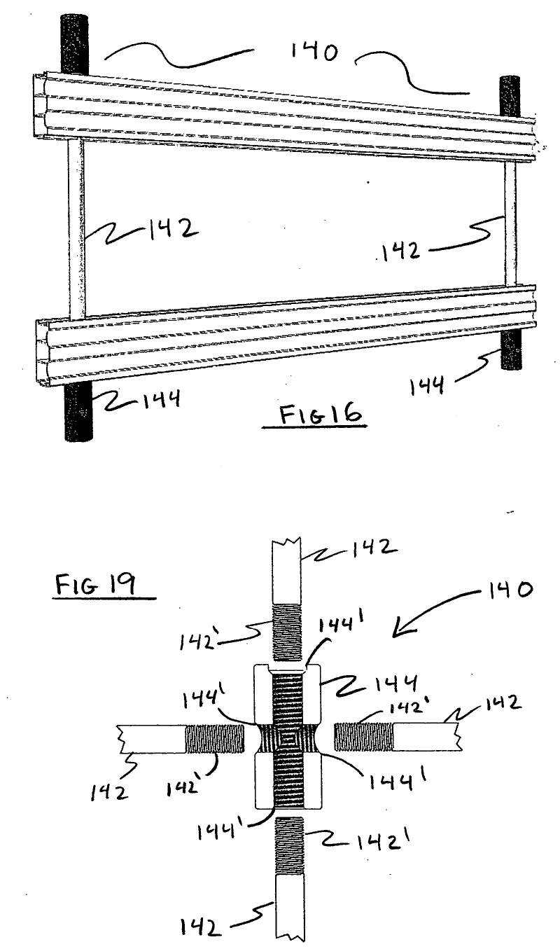

In at least one embodiment of the present invention, the modular construction member 118 has an elongated configuration and comprises an interior portion 119 and an exterior portion 119′. The modular construction member 118, in one preferred embodiment, includes a pair of oppositely disposed major faces 121 disposed in an opposing spaced relation with one another, and an adjoining pair of oppositely disposed minor faces 121′, as illustrated in FIG. 15. Both the major faces 121 and the minor faces 121′ comprise a generally planar configuration and are cooperatively structured to define the generally rectangular configuration of the modular construction member 118. Additionally, the modular construction member 118 of this preferred embodiment also comprises a passageway 126, as illustrated in FIG. 15 and as described in detail below.

In one preferred embodiment, the modular construction member 118 includes at least one internal support element 132 disposed pair of oppositely disposed major faces 121 so as to provide additional structural integrity to the modular construction member 118. In one further preferred embodiment, the modular construction member 118 comprises a plurality of internal support elements 132 structured to interconnect the pair of oppositely disposed major faces 121 to provide additional structural integrity to the modular construction member 118, as illustrated in FIG. 15.

Also, in a preferred embodiment, at least one of the pair of oppositely disposed major faces 121 of the modular construction member 118 comprises at least one non-planar portion 121″ structured and disposed to provide additional structural integrity to the modular construction member 118. In a most preferred embodiment, at least one of the pair of major faces 121 of the modular construction member 118 of the present invention comprises a plurality of non-planar portions 121″ each being structured and disposed to provide additional structural integrity to said modular construction member 118. As illustrated in the preferred embodiment of FIG. 15, the non-planar portions 1219″ may comprise a generally regular concave scalloped configuration, however, it is understood that the non-planar portions 121″ of the present invention may comprise other regular or irregular configurations which are included within the scope and intent of the present invention.

One further preferred embodiment of the modular construction member 118 of the present invention includes at least one rib member 135 disposed along a length of the member 118 structured and disposed to provide additional structural integrity thereto. As shown in the preferred embodiment of FIG. 13 the rib member 135 is preferably affixed within the interior portion 119 of the modular construction member 118. In at least one embodiment, the rib member 135 is integrally constructed along a length of the interior portion 119 of the modular construction member 118 of the present invention.

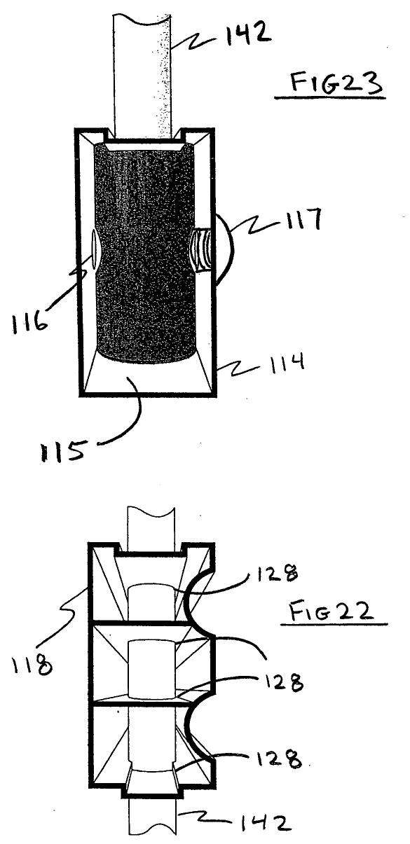

As further illustrated in FIG. 15A, the passageway 126 of the modular construction member 118 preferably comprises a plurality of passages 128 formed in oppositely disposed minor faces 121′ of the modular construction member 118 and extending through the interior portion 119 thereof. As further illustrated in FIG. 15A, the passages 128 also extend through the plurality of internal support elements 132 of the modular construction member 118. As such, the passages 128 are disposed and dimensioned to receive and allow passage therethrough of at least a portion of a corresponding interconnection assembly 140, and as described in detail hereinafter. In at least one preferred embodiment, the passages 128 have a substantially round or circular configuration so as to correspond to a preferred sectional configuration of the interconnection assembly 140 or, more specifically, a sectional configuration of an interconnection member 142, which preferably comprise a cylindrical configuration, to permit passage of the interconnection member 142 therethrough, as illustrated in FIG. 22. Other sectional configurations of both the interconnection member 142, and the corresponding passages 128 are of course included within the intended spirit and scope of the present invention, including, but not limited to elliptical, polygonal, etc.

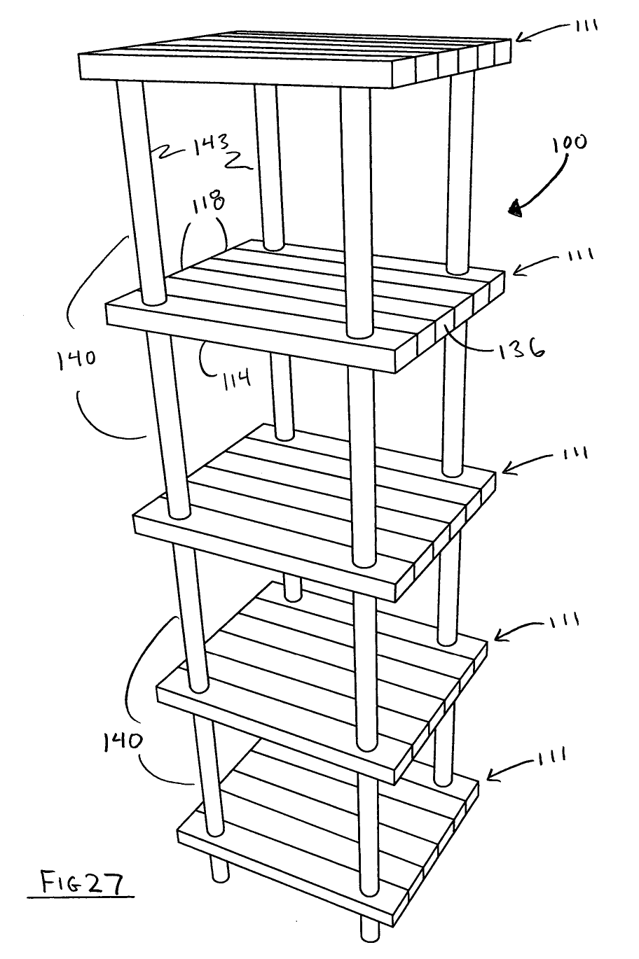

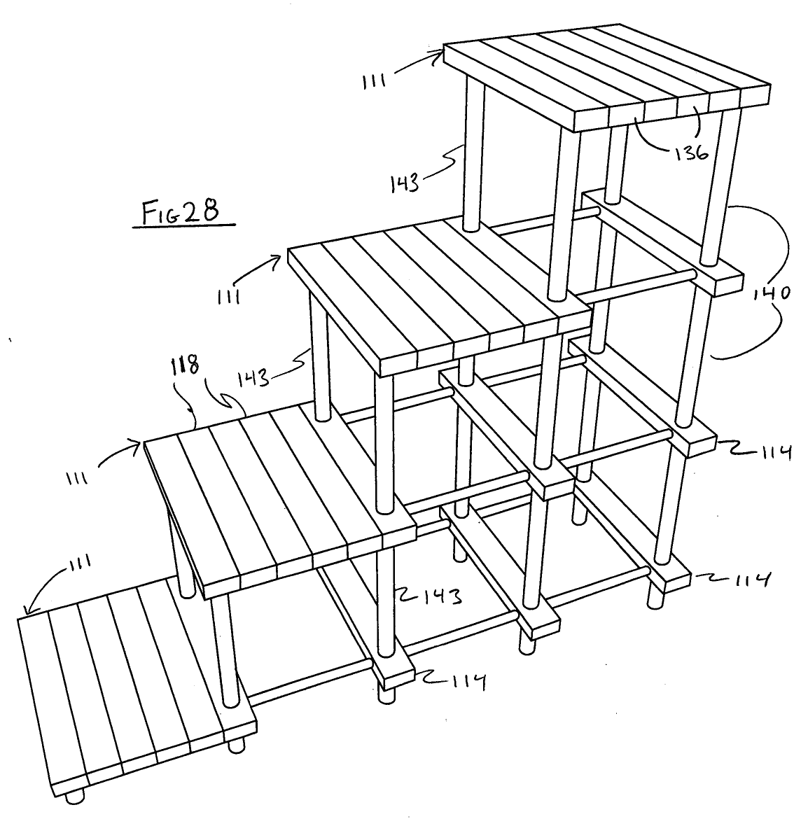

With further reference to FIGS. 15 and 15A, it is seen that each of the plurality of modular construction members 118 preferably comprise a substantially hollow interior configuration as at 119 extending along at least a portion of the length thereof, to reduce the weight of each of the modular construction members 118. In this “hollow” embodiment, the modular construction members 118 may also include closed end caps 136, as may be seen, for example, in FIGS. 25 through 28. However, it is understood that, alternatively, the plurality of modular construction members 118 may comprise a substantially solid configuration being constructed of a, preferably, lightweight yet high strength material.

As shown in the figures, the plurality of passages 128 of the passageway 126 of the modular construction member 118 are cooperatively structured to align with the plurality of passages 128 of the passageway 126 of adjacent modular construction members 118 so as to facilitate the passage therethrough of the one or more interconnection members 142 of the interconnection assembly 140. This cooperative association between the passageways 126 of the plurality of modular construction members 118 and the one or more interconnection members 142 thereby facilitates the removable interconnection or securement of the individual modular construction members 118 of each modular construction unit 111 to one another. Thus, the modular construction members 118 of the present invention may be disposed in any one of a plurality of different arrays, for example, the “closed” array of FIG. 13 or the “partially open” array of FIG. 14, such that each modular construction unit 111 may assume any of a plurality of configurations as may be required by the particular structure being assembled therefrom.

Additionally, in at least one embodiment, the present invention may comprise a joining assembly structured to join adjacent and abutting ones of the modular construction units 111 to one another as may be necessitated by a specific structure to be assembled. The joining assembly may include a plurality of joining pins affixed along the periphery of at least some of the modular construction members 118, the pins positioned to align with one another when the corresponding modular construction units 111 are disposed in an adjacent and abutting relation. In addition, in this embodiment, the joining assembly may comprise a plurality of slotted connectors structured to engage corresponding pins from adjacent modular construction units 111, the slotted connectors structured to draw the modular construction units 111 together and securely upon rotational engagement with the pins, similar to the type of connectors commonly found on ready to assemble furniture.

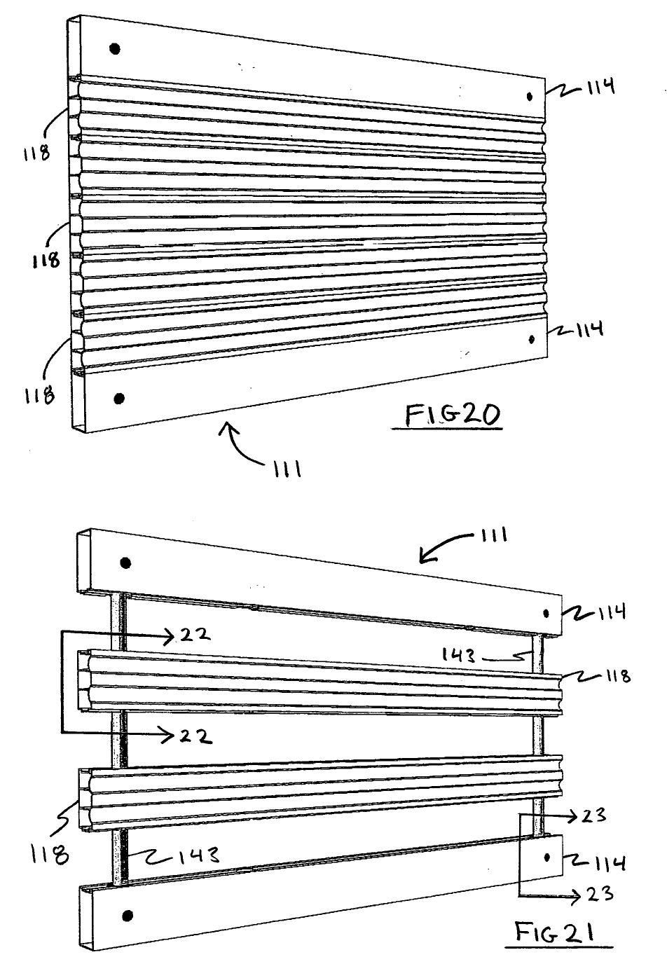

The interconnection assembly 140 of the present invention includes at least one interconnection member 142 and one interconnection bushing 144, such as are illustrated, by way of example only, in FIGS. 17 and 18, respectively. In one preferred embodiment, the interconnection assembly 140 comprises a plurality of interconnection members 142 disposed in spaced, and preferably parallel relation to one another, as best shown in FIG. 16, are securely yet removably interconnected to corresponding ones of a plurality of interconnection bushings 144.

Each of the interconnection members 142 have opposite ends 142′ which are threaded or otherwise structured to facilitate interconnection to a corresponding interconnection bushing 144. Looking at the preferred embodiment of FIG. 17, the opposite ends 142′ of the interconnection member 142 are threaded to facilitate secure yet removable connection to a corresponding interconnection bushings 144, the interconnection assembly 140 preferably comprising a plurality of interconnection bushings 144. FIG. 18 is a perspective view of one preferred embodiment of an interconnection bushing 144 of the present invention. Each interconnection bushing 144 preferably comprises a plurality of interconnection ports 144′ disposed at opposite ends and along opposite sides of the bushing 144. In one preferred embodiment, each of the interconnection ports 144′ are threaded such that a correspondingly threaded end 142′ of an interconnection member 142 may be positioned into the interconnection port 144′ and threadedly yet removably secured to the interconnection bushing 144, as best illustrated in the partially exploded cross-sectional view of FIG. 19. It is, of course, understood that other mechanical interconnections may be utilized between the interconnection members 142 and the interconnection bushings 144, such as, by way of example only, quick connect fittings, bolts, cotter pins and keyways, etc., just to name a few.

The interconnection assembly 140, and in particular, the plurality of interconnection members 142, serve to interconnect the plurality of modular construction members 118 to one another in their intended operative position. As such, each of the plurality of interconnection members 142 comprises a sufficiently elongated configuration to extend through the corresponding passageways 126 of each of a plurality of modular construction members 118 being removably secured thereto by corresponding interconnection bushings 144, as shown in FIGS. 13 and 14, so as to at least partially define one dimension of the corresponding modular construction unit 111.

It is also emphasized that the number and specific positioning of the one or more interconnection members 142 may vary dependent on the dimensional and configurational requirements of each modular construction unit 111. Also, to provide additional structural integrity to each modular construction unit 111, each of the interconnection members 142, as well as the corresponding interconnection bushings 144 and the plurality of modular construction members 118 are formed from a substantially rigid, high strength material such as aluminum, aluminum alloy, steel or other metals. It is of course contemplated that other materials having sufficient structural integrity may be utilized including, but not limited to, wood, high strength plastics, etc.

As set forth above, the interconnection assembly 140 serves to securely yet removably interconnect a plurality of modular construction members 118 to one another in any of a plurality of arrays such as, once again, by way of example, the “closed” arrangement of FIG. 13 and the “partially open” arrangement of FIG. 14, thereby forming a plurality of configurations of the modular construction units 111. In the “partially open” arrangement of FIG. 14, the interconnection assembly 140 further comprises a plurality of spacers 143. More in particular, the spacers 143 are structured to overly a portion of the interconnection member 142 disposed between adjacent ones of the modular construction members 118, so as to provide a predetermined and, preferably, uniform distance between adjacent ones of the modular construction members 118. As illustrated throughout the figures, it is well within the scope and understanding of the present invention to encompass both horizontally and vertically oriented arrays of the plurality of modular construction members 118 to form the modular construction unit 111.

In at least one embodiment, the plurality of modular construction members 118 are structured and disposed to engage and at least partially interlock with adjacent modular construction members 118, via interlock channel 133 and interlock ridge 134, such as in FIG. 15. In one further preferred embodiment, one or more cover member 114, as are discussed more fully below, may also comprise an interlock channel 133 and/or an interlock ridge 134 to facilitate interlocking with a confronting modular construction member 118, thereby providing additional structural integrity to the modular construction unit 111 when the plurality of modular construction members 118 are arranged in a “closed” and interlocked configuration, as illustrated in FIG. 20.

It is once again noted that the modular construction members 118 of the present invention may be disposed in any of a plurality of predetermined arrays, thus, a greater or lesser number of the modular construction members 118 may be disposed in spaced relation to one another in each modular construction unit 111. The number of modular construction members 118 utilized for each modular construction unit 111 may of course also vary dependent on the overall size and configuration of the particular structure being assembled with the modular construction assembly 100, as may be seen from the structures illustrated in FIGS. 24 through 28.

In at least one embodiment, each of the modular construction members 118 may be disposed in confronting relation and adjacent to at least one other modular construction member 118. Also, the outermost or terminal modular construction members 118 may be disposed in a confronting arrangement with a corresponding cover member 114, such as is illustrated in FIG. 20. The cover member 114 is preferably structured to comprise substantially the same external configuration of the corresponding modular construction members 118, preferably including a corresponding interlock channel 133 and/or interlock ridge 134. Additionally, the cover member 114 is structured to engage and interconnect to the interconnection bushings 144 extending outwardly from the outermost or terminal modular construction member 118. As may be further seen in FIG. 20, the cover members 114 serve to at least partially define a periphery of the modular construction unit 111.

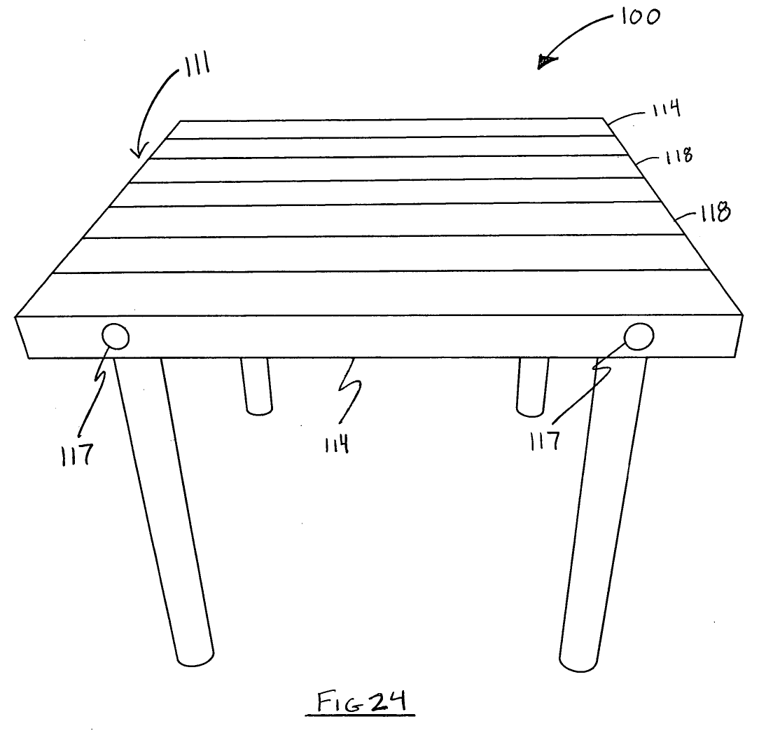

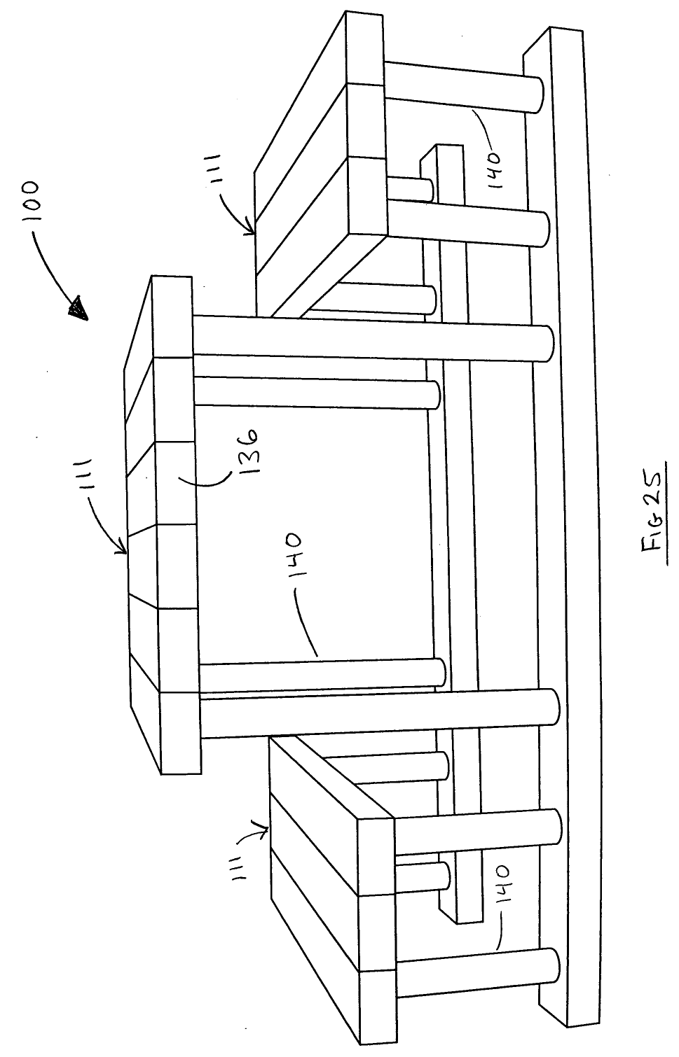

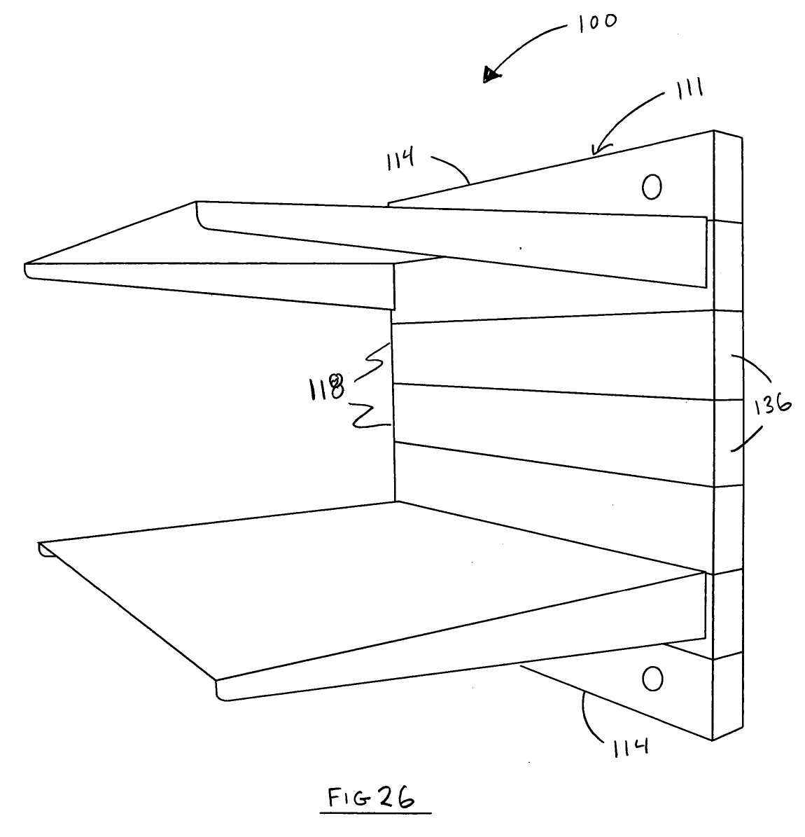

More in particular, the cover member 114 preferably comprises a hollow interior portion 115 structured to receive at least one, but preferably a plurality of interconnection bushings 144 therein, for example, as shown in FIG. 23. The cover member 114 further comprises a plurality of interconnection apertures 116, as in FIG. 23, each structured and disposed such that each of the interconnection ports 144′ of an interconnection bushing 144 received therein aligns with one of the plurality of interconnection apertures 116 in the cover member 114. The interconnection apertures 116 permit the removable connection of a corresponding interconnection member 142 therethrough. Also as illustrated in FIG. 23, in at least one embodiment, the interconnection assembly may comprise one or more cap 117, also structured to be removably yet securely interconnected to the interconnection bushings 144. The cap(s) 117 serve not only to protect the interconnection port 144′ when not operatively engaging a corresponding interconnection member 142, the cap(s) 117 may also serve to securely retain the corresponding interconnection bushing 144 in an operative position within the cover member 114.

In one further preferred embodiment of the modular construction assembly 100, the interconnection assembly 140, is further structured and disposed to facilitate the interconnection of the plurality of modular construction units 111 to one another to form any of a variety of structures including but not limited to the structures illustrated in FIGS. 24 through 28. As may be seen from the figures, and in light of the foregoing disclosure, this versatility is due on part to the arrangement of the interconnection ports 144′ on each of the interconnection bushings 144, which permits removable attachment of an interconnection member 142 in a variety of dispositions. More in particular, the plurality of interconnection bushings 144 are structured and disposed to receive at least a portion of one interconnection member 142 in each of the plurality of interconnection ports 144′. As such, the interconnection member 142 may be disposed between a plurality of modular construction members 118 comprising one modular construction unit 111, as illustrated in FIGS. 13, 14, 20, 21, or the interconnection member 142 may be disposed between the plurality of modular construction units 111 comprising one of the variety of structures which may be assembled utilizing the modular construction assembly 100 of the present invention, including, by way of example only, the structures illustrated in FIGS. 24 through 28.

As such, the modular construction units 111 of the modular construction assembly 100 of the present invention may be quickly, easily, and removably interconnected to one another to facilitate the construction of any one of a plurality of structures. Moreover, each of the plurality of modular construction members 118 of each modular construction unit 111 may be disposed in any one of a variety of arrays including, but in no manner limited to, those illustrated throughout the figures, thereby providing further flexibility to the numerous structures which may be constructed utilizing the modular construction assembly 100 of the present invention.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

1. A modular construction assembly for the construction of a variety of structures, said assembly comprising:
at least one modular construction unit comprising a plurality of modular construction members collectively disposed in at least one predetermined array,
each of said plurality of modular construction members comprising a passageway extending therethrough,
an interconnection assembly structured to operatively engage said plurality of modular construction members, and
at least a portion of said interconnection assembly structured and disposed to extend through said passageway of each of said plurality of modular construction members comprising said modular construction unit.

2. The modular construction assembly as recited in claim 1 wherein said interconnection assembly comprises a plurality of interconnection members, said interconnection members comprising an elongated configuration having opposite ends.

3. The modular construction assembly as recited in claim 2 wherein said plurality of interconnection members are disposed in spaced relation to one another and are structured to facilitate removable interconnection of said plurality of modular construction members to one another in said predetermined array.

4. The modular construction assembly as recited in claim 3 wherein said interconnection assembly further comprises a plurality of interconnection bushings structured to securely yet removably interconnect said plurality of modular construction members to one another in said at least one predetermined array.

5. The modular construction assembly as recited in claim 4 wherein each of said plurality of interconnection bushings comprises at least one interconnection port structured to securely yet removable engage at least one of said opposite ends of a corresponding one of said interconnection members.

6. The modular construction assembly as recited in claim 4 wherein each of said plurality of interconnection bushings comprises a plurality of interconnection ports each structured to securely yet removable engage at least one of said opposite ends of one of said plurality of interconnection members.

7. The modular construction assembly as recited in claim 2 wherein said plurality of interconnection members are disposed in spaced relation to one another and transverse to said plurality of modular construction members.

8. The modular construction assembly as recited in claim 2 wherein said at least one predetermined array comprises said plurality of modular construction members disposed in transverse relation to said plurality of interconnection members and oriented in a substantially parallel relation to one another.

9. The modular construction assembly as recited in claim 1 wherein said passageway of each of said plurality of modular construction members comprises a plurality of passages each structured to receive at least said portion of said interconnection assembly therethrough.

10. The modular construction assembly as recited in claim 9 wherein said plurality of passages of each said passageway are disposed along a length of a corresponding one of said plurality of modular construction members.

11. The modular construction assembly as recited in claim 2 wherein said plurality of modular construction members and said plurality of interconnection members are cooperatively structured for removable yet secure interconnection with one another.

12. The modular construction assembly as recited in claim 1 wherein each of said plurality of modular construction members further comprises a rib member affixed along a length of said modular construction member, said rib member being structured and disposed to provide structural integrity to said modular construction member.

13. The modular construction assembly as recited in claim 1 wherein each of said plurality of modular construction members further comprises at least one pair of oppositely disposed faces.

14. The modular construction assembly as recited in claim 13 wherein each of said plurality of modular construction members further comprises at least one internal support element disposed along a length of said modular construction member and structured to interconnect said pair of faces of said modular construction member and provide structural integrity thereto.

15. The modular construction assembly as recited in claim 13 wherein at least one of said pair of faces comprises a plurality of non-planar portions structured and disposed to provide structural integrity to said modular construction member.

16. The modular construction assembly as recited in claim 1 wherein each of said plurality of modular construction members includes at least one pair of oppositely disposed faces wherein at least one of said pair of faces comprises a plurality of non-planar portions structured and disposed to provide structural integrity to said modular construction member.

17. A modular construction member comprising:
an elongated configuration having an interior portion and an exterior portion,
a pair of oppositely disposed major faces and an adjoining pair of oppositely disposed minor faces,
at least one internal support element disposed along a length of said modular construction member and structured to interconnect said pair of major faces to provide structural integrity thereto,
at least one of said pair of major faces comprising at least one non-planar portion structured and disposed to provide structural integrity to said modular construction member, and
a passageway formed through said modular construction member structured to receive at least a portion of an interconnection assembly therethrough.

18. The modular construction member as recited in claim 17 wherein said passageway comprises a plurality of passages disposed along a length of said modular construction member, each of said plurality of passages structured to receive at least said portion of said interconnection assembly therethrough.

19. The modular construction member as recited in claim 17 further comprising a plurality of internal support elements disposed in a spaced apart relation along said length of said modular construction member each structured to interconnect said pair of major faces and provide structural integrity to said modular construction member.

20. The modular construction member as recited in claim 17 wherein said at least one of said pair of major faces comprises a plurality of non-planar portions structured and disposed to provide structural integrity to said modular construction member.

21. The modular construction member as recited in claim 17 further comprising a rib member disposed along a length of said modular construction member structured and disposed to provide structural integrity to said modular construction member.

22. The modular construction member as recited in claim 21 wherein said rib member is affixed along said interior portion of said modular construction member.

23. The modular construction member as recited in claim 17 further comprising an interlock channel and an interlock ridge disposed along said exterior portion in an opposing relation, said interlock ridge of one said modular construction member structured to be removably receivable into said interlock channel of an adjacent modular construction member in an interlocking relation.

24. A modular construction assembly comprising:
a plurality of modular construction units each comprising a plurality of modular construction members collectively disposed in one of a plurality of predetermined arrays,
each of said plurality of modular construction members comprising a passageway extending therethrough,
an interconnection assembly structured to operatively engage said plurality of modular construction members,
said interconnection assembly comprising a plurality of interconnection members, each of said interconnection members comprising an elongated configuration and having opposite ends,
at least some of said plurality of interconnection members structured and disposed to extend through said passageways of said plurality of modular construction members, and
said interconnection assembly further structured to securely yet removably interconnect said plurality of modular construction units to one another in said one of said plurality of predetermined configurations.

25. The modular construction assembly as recited in claim 24 wherein each of said plurality of modular construction members of one of said plurality of modular construction units is removably interconnected to corresponding ones of said plurality of interconnection members of said interconnection assembly.

26. The modular construction assembly as recited in claim 24 wherein said interconnection assembly further comprises a plurality of interconnection bushings each structured to be removably secured to at least one of said opposite ends of said plurality of interconnection members.

27. The modular construction assembly as recited in claim 26 wherein at least one of said plurality of interconnection bushings is removably and threadedly secured to each of said opposite ends of each of said plurality of interconnection members of one of said plurality of modular construction units.

28. The modular construction assembly as recited in claim 24 wherein at least one interconnection member is structured and disposed to interconnect at least one pair of modular construction units to one another in said at least one predetermined configuration.

29. The modular construction assembly as recited in claim 24 wherein a plurality of said interconnection members are structured and disposed to interconnect said plurality of modular construction units to one another in said at least one predetermined configuration.

30. A modular construction assembly comprising:
a plurality of modular construction units each comprising a plurality of modular construction members collectively disposed in one of a plurality of predetermined arrays,
each of said plurality of modular construction members comprising a passageway extending therethrough,
each said passageway comprising a plurality of passages disposed along a length of a corresponding one of said plurality of modular construction members,
an interconnection assembly structured to operatively engage said plurality of modular construction members,
each of said plurality of modular construction units comprising a plurality of cover members cooperatively disposed with said plurality of modular construction members in said predetermined array, said cover members structured and disposed to at least partially define a periphery of a corresponding one of said plurality of said modular construction units,
said interconnection assembly comprising a plurality of interconnection members, each of said interconnection members comprising an elongated configuration and having opposite ends,
at least some of said plurality of interconnection members structured and disposed to extend through at least a portion of said passageways of said plurality of modular construction members,
said interconnection assembly further comprising a plurality of interconnection bushings each structured to be removably secured to at least one of said opposite ends of at least one of said plurality of interconnection members, and
said interconnection assembly further structured to securely yet removably interconnect said plurality of modular construction units to one another in at least one predetermined configuration.

31. The modular construction assembly as recited in claim 30 wherein said at least one predetermined configuration comprises a table.

32. The modular construction assembly as recited in claim 30 wherein said at least one predetermined configuration comprises a shelf.

33. The modular construction assembly as recited in claim 30 wherein said at least one predetermined configuration comprises a staircase.
